(19) United States
(12) Patent Application Publication
(10) Pub. No.: US 2012/0281406 A1
(43) Pub. Date: Nov. 8, 2012

(54) LIGHT EMITTING DIODE LAMP

(75) Inventors: Shih-Che TSENG, Hsinchu City (TW); Mao-Sung HSU, Hsinchu City (TW)

(73) Assignee: TYNTEK CORPORATION, Hsinchu City (TW)

(21) Appl. No.: 13/240,649

(22) Filed: Sep. 22, 2011

(30) Foreign Application Priority Data
May 4, 2011 (CN) 201110113993.X

(51) Int. Cl. F21V 7/00; F21V 29/00

(52) U.S. Cl. 362/247; 362/235

(57) ABSTRACT

An LED lamp includes a lamp base, a heat-dissipating unit, a reflecting unit, a board, and at least one LED mounted on one side of the board facing toward the lamp base. The heat-dissipating unit includes a plurality of heat-dissipating fins disposed spacedly along a periphery of the lamp base. The reflecting unit has a reflector portion and is connected in a thermal-conducting manner to a side of the heat-dissipating fins opposite to the lamp base. The board is connected to the reflecting unit in a manner that the board is spaced apart from the reflector portion, and is formed with at least one light-transmissive portion. The LED has a light exit side facing toward the reflector portion. Light emitted by the LED is reflected by the reflector portion and exits the LED lamp via the light-transmissive portion of the board.

### CROSS-REFERENCE TO RELATED APPLICATION

This application claims priority of Chinese Application No. 201110113993.X, filed on May 4, 2011.

### BACKGROUND OF THE INVENTION

1. Field of the Invention

The invention relates to a lamp, more particularly to a light emitting diode (LED) lamp.

2. Description of the Related Art

LED devices are replacing tungsten filament bulbs in many lighting applications. Nevertheless, the removal of heat produced by the LED device remains a critical issue since the heat, if not removed properly, raises the temperature of the LED device and may impair its service life and brightness. A heat dissipating mechanism for cooling the LED device is therefore required.

A variety of heat dissipating mechanisms have been developed for cooling the LED device, most of which stress on improvements to the structure of the heat dissipating mechanisms, rather than emphasizing on how to efficiently conduct heat from the LED device to the heat dissipating mechanisms. Moreover, in a conventional lamp device, a wire is likely to be positioned at a heat conducting pathway, thereby resulting in heat damage to the wire.

### SUMMARY OF THE INVENTION

The object of the present invention is to provide an LED lamp with a heat conducting mechanism that efficiently conducts heat from the LED to heat-dissipating fins.

Accordingly, an LED lamp of the present invention includes a lamp base, a heat-dissipating unit, a reflecting unit, a board, and at least one LED mounted on one side of the board facing toward the lamp base. The heat-dissipating unit includes a plurality of heat-dissipating fins disposed spacedly along a periphery of the lamp base. The reflecting unit has a reflector portion and is connected in a thermal-conducting manner to a side of the heat-dissipating fins opposite to the lamp base. The board is connected to the reflecting unit in a manner that the board is spaced apart from the reflector portion, and is formed with at least one light-transmissive portion. The board further has a thermal conductor layer in thermal conduction contact with the reflecting unit. The LED has a light exit side facing toward the reflector portion. Light emitted by the LED is reflected by the reflector portion and exits the LED lamp via the light-transmissive portion of the board.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of an LED lamp according to the invention; and

FIG. 2 is a partly sectional view of the LED lamp shown in FIG. 1.

### DETAILED DESCRIPTION OF THE PREFERRED EMBODIMENT

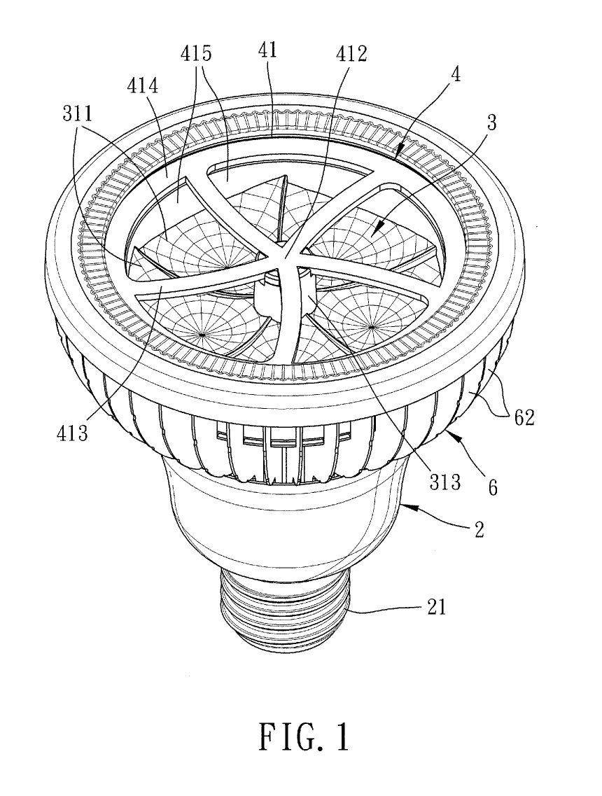

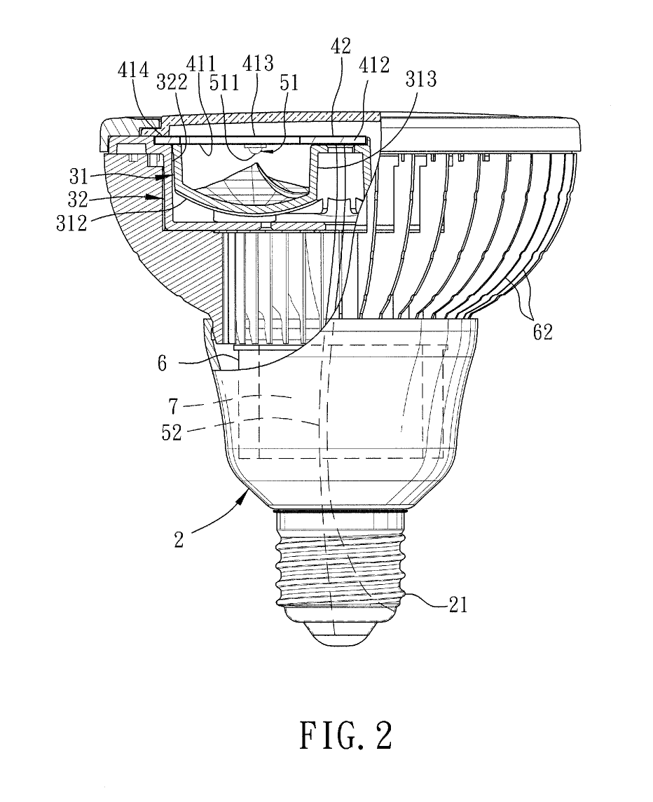

As shown in FIGS. 1 and 2, the preferred embodiment of an LED lamp according to the present invention comprises a lamp base 2, a reflecting unit 3, a board 4, a plurality of LEDs 51, and a heat-dissipating unit 6.

The heat-dissipating unit 6 includes a plurality of heat-dissipating fins 62 disposed spacedly along a periphery of the lamp base 2.

The reflecting unit 3 is connected in a thermal-conducting manner to a side of the heat-dissipating fins 62 opposite to the lamp base 2, and has a reflector portion 31.

The board 4 is connected to the reflecting unit 3 in a manner that the board 4 is spaced apart from the reflector portion 31. The board 4 has one side 411 facing toward the lamp base 2 and is formed with at least one light-transmissive portion 415. The board 4 further has a thermal conductor layer 42 in thermal conduction contact with the reflecting unit 3. In this embodiment, the thermal conductor layer 42 is made of a metal material such as copper for enhancing the heat-conducting effect.

The LEDs 51 are mounted on the side 411 of the board 4 and have a light exit side 511 facing toward the reflector portion 31. Light emitted by the LEDs 51 is reflected by the reflector portion 31 and exits the LED lamp via the light-transmissive portion 415 of the board 4.

The reflector portion 31 includes a plate body 312, and a plurality of reflecting surface parts 311 that correspond to the light exit sides 511 of the LEDs 51 respectively, and that are formed on the plate body 312, and arranged to surround an axis passing through the plate body 312. In this embodiment, the LED lamp includes five LEDs 51 and five reflecting surface parts 311.

The reflecting unit 3 includes a receiving cup 32 formed with a receiving space 322 for receiving the reflecting portion 31. In this embodiment, the receiving cup 32 is made of a metal material, which has a good heat-conducting effect.

The board 4 includes an inner portion 412, an outer portion 414 that surrounds the inner portion 412 and that is disposed in thermal conduction contact with a fringe of an open side of the receiving cup 32, and a plurality of connecting portions 413 that ext end between and that have opposite ends connected respectively to the inner portion 412 and the outer portion 414. In this embodiment, the board 4 includes five connecting portions 413. The five LEDs 51 are mounted on the five connecting portions 413 at the side 411 of the board 4. An electrical-insulating varnish layer is formed between each of the LEDs 51 and a respective one of the connecting portions 413 so as to avoid short-circuiting the LEDs 51 due to the thermal conductor layer 42 of the board 4. Moreover, the light-transmissive portions 415 are formed among the inner portion 412, the outer portion 414 and the connecting portions 413.

The plate body 312 is formed with a post 313 that is surrounded by the reflecting surface parts 311, and the inner portion 412 is disposed in thermal conduction contact with the post 313.

The lamp base 2 is formed with an electrical coupling end 21, the post 313 of the plate body 312 is hollow, and the LED lamp further includes a plurality of wires 52 connected electrically to the LEDs 51, and extending from the inner portion 412 of the board 4, through the post 313 of the plate body 31 and into the lamp base 2 to connect electrically with the electrical coupling end 21. That is, the inner portion 412 of the board 4, the post 313, and the lamp base 2 cooperately form a passage 7 for the wires 52 inside the LED lamp.

The heat dissipation path of the LED lamp starts from the connecting portions 413. To be specific, heat produced by the LEDs 51 during operation is transferred to the thermal conductor layer 42 at the connecting portions 413 of the board 4, where a portion of heat is dissipated. The remaining heat is then conducted to the outer portion 414 of the board 4, which is in thermal conduction contact with the receiving cup 32, and further to the heat-dissipating fins 62, the receiving cup 32 and the heat-dissipating fins 62 being both capable of dissipating the remaining heat.

In this embodiment, the reflecting unit 3 and the heat-dissipating unit 6 are made of metal. However, it is worth mentioning that, since the board 4 is configured to have a good heat-conducting effect and since the heat dissipation path does not pass through the reflector portion 13, the reflector portion 31, including the plate body 312, may be made of a plastic material, without suffering from deformation attributed to accumulated heat.

An additional effect of the present invention is to provide protection to the wires 52. To be specific, since the passage 7 for the wires 52 avoids the heat dissipation path of the LED lamp, heat can be dissipated without affecting the wires 52, thereby reducing risk of incurring heat-related problems such as short-circuit, embrittlement and rupture of the wires 52.

To sum up, the present invention mounts the LEDs 51 on the connecting portions 413 at the side 411 of the board 4, thereby transferring heat to the thermal conductor layer 42, and consequently to the receiving cup 32 and the heat-dissipating fins 62. This configuration can enhance the heat-dissipating effect. Moreover, the wires 52, specifically routed to pass the passage 7, are protected from being undesirably heated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light-emitting diode (LED) lamp comprising:
a lamp base;
a heat-dissipating unit including a plurality of heat-dissipating fins disposed spacedly along a periphery of said lamp base;
a reflecting unit connected in a thermal-conducting manner to a side of said heat-dissipating fins opposite to said lamp base, said reflecting unit having a reflector portion;
a board connected to said reflecting unit in a manner that said board is spaced apart from said reflector portion, said board having one side facing toward said lamp base and being formed with at least one light-transmissive portion, said board further having a thermal conductor layer in thermal conduction contact with said reflecting unit; and
at least one LED mounted on said one side of said board and having a light exit side facing toward said reflector portion;
wherein light emitted by said LED is reflected by said reflector portion and exits said LED lamp via said light-transmissive portion of said board.

2. The LED lamp as claimed in claim 1, comprising a plurality of said LEDs mounted on said board, wherein said reflector portion includes a plurality of reflecting surface parts corresponding to said light exit sides of said LEDs, respectively.

3. The LED lamp as claimed in claim 2, wherein said reflector portion includes a plate body, said reflecting surface parts being formed on said plate body and being arranged to surround an axis passing through said plate body.

4. The LED lamp as claimed in claim 3, wherein said board includes an inner portion, an outer portion that surrounds said inner portion, and a plurality of connecting portions that extend between and that have opposite ends connected respectively to said inner portion and said outer portion, said LEDs being mounted on said connecting portions, said board having a plurality of said light-transmissive portions formed among said inner portion, said outer portion, and said connecting portions.

5. The LED lamp as claimed in claim 4, wherein said plate body is formed with a post that is surrounded by said reflecting surface parts, and said inner portion is disposed in thermal conduction contact with said post.

6. The LED lamp as claimed in claim 5, wherein:
said lamp base is formed with an electrical coupling end;
said post of said plate body is hollow; and
said LED lamp further comprises a plurality of wires connected electrically to said LEDs, and extending from said inner portion of said board, through said post of said plate body and into said lamp base to connect electrically with said electrical coupling end.

7. The LED lamp as claimed in claim 1, wherein said thermal conductor layer of said board is made of a metal material.

8. The LED lamp as claimed in claim 3, wherein said plate body of said reflector portion is made of a plastic material.
